(19) United States
(12) Patent Application Publication
(10) Pub. No.: US 2022/0318071 A1
(43) Pub. Date: Oct. 6, 2022

(54) LOAD BALANCING METHOD AND RELATED DEVICE

(71) Applicant: Huawei Technologies Co., Ltd., Shenzhen (CN)

(72) Inventors: Guocheng ZHONG, Dongguan (CN); Xinhai XU, Nanjing (CN); Baochuan CHENG, Dongguan (CN); Yunlong WANG, Dongguan (CN)

(21) Appl. No.: 17/843,754

(22) Filed: Jun. 17, 2022

Related U.S. Application Data
(63) Continuation of application No. PCT/CN2020/106021, filed on Jul. 30, 2020.

(30) Foreign Application Priority Data
Dec. 19, 2019 (CN) 201911323403.9

(51) Int. Cl. G06F 9/50; H04L 41/12

(52) U.S. Cl. CPC G06F 9/5083; G06F 9/5077; G06F 9/5038; H04L 41/12; G06F 2209/505

(57) ABSTRACT

A load balancing method and a related device is provided. The method includes: determining topology information of each of a plurality of smallest management units pods in a load balancing cluster to which a first node belongs, where the plurality of pods are distributed on at least two nodes; determining a weight of each of the plurality of pods based on the topology information of each pod; and selecting a target pod from the plurality of pods based on the weight of each pod, where the target pod is configured to process a currently to-be-processed task in the first node. In embodiments of this application, network overheads can be reduced when a task request is allocated.

### CROSS-REFERENCE TO RELATED APPLICATIONS

This application is a continuation of International Application No. PCT/CN2020/106021, filed on Jul. 30, 2020, which claims priority to Chinese Patent Application No. 201911323403.9, filed on Dec. 19, 2019. The disclosures of the aforementioned applications are hereby incorporated by reference in their entireties.

### TECHNICAL FIELD

This application relates to the field of computer technologies, and in particular, to a load balancing method and a related device.

### BACKGROUND

Load balancing refers to allocating task requests to a plurality of nodes in a load balancing cluster according to a scheduling algorithm, to improve a task processing capability of the load balancing cluster. In a container network scenario, load balancing in a container orchestration and management platform (for example, Kubernetes) is implemented by deploying distributed software on the nodes in the load balancing cluster. The manner of allocating the task requests according to the existing scheduling algorithm by using the distributed software is prone to cause additional network overheads. Therefore, how to reduce network overheads when a task request is allocated is a technical problem being studied by a person skilled in the art.

### SUMMARY

This application discloses a load balancing method and a related device, so that network overheads can be reduced when a task request is allocated.

A first aspect of this application discloses a load balancing method, including:

determining topology information of each of a plurality of smallest management units pods in a load balancing cluster to which a first node belongs, where the plurality of pods are distributed on at least two nodes, for example, some are distributed on the first node, some are distributed on a node connected to a same top-of-rack switch as the first node, some are distributed on a node connected to a same leaf switch as the first node, and some are distributed on a node connected to a same spine switch as the first node; and a quantity of pods distributed on each of the at least two nodes is not limited herein;

determining a weight of each of the plurality of pods based on the topology information of each pod; and

selecting a target pod from the plurality of pods based on the weight of each pod, where the target pod is configured to process a currently to-be-processed task in the first node.

In the foregoing method, the weight of each pod is determined based on the topology information of each pod, so that a location relationship of each pod is quantized. Therefore, a value of the weight of a pod can reflect a quantity of layers of switches between a node in which the pod is located and the first node. Then a target pod spaced from the first node by a small quantity of layers of switches may be selected based on a value of the weight of each pod, to process the currently to-be-processed task in the first node, so that a pod spaced from the first node by a large quantity of layers of switches is prevented from being selected to process the currently to-be-processed task in the first node, thereby reducing network overheads.

In an optional solution of the first aspect, the determining topology information of each of a plurality of smallest management units pods in a load balancing cluster to which a first node belongs includes:

receiving the topology information of each of the plurality of pods that is sent by a control node.

In the foregoing method, the first node directly receives the topology information of each of the plurality of pods that is sent by the control node, without collecting LLDP information of another computing node. This is quicker and reduces time for selecting the target pod.

In another optional solution of the first aspect, the determining topology information of each of a plurality of smallest management units pods in a load balancing cluster to which a first node belongs includes:

collecting Link Layer Discovery Protocol (LLDP) information of the at least two nodes; and

generating the topology information of each of the plurality of pods based on the LLDP information of the at least two nodes.

In the foregoing method, the first node needs to communicate with the at least two nodes, collect the LLDP information of the at least two nodes, and generate the topology information of each of the plurality of pods based on LLDP information collected in real time. The manner of generating the topology information is more accurate.

When all of the plurality of pods have same load, a pod with a smallest weight may be selected from the plurality of pods as the target pod. Because a quantity of layers of switches between the pod with the smallest weight and the first node is the smallest, the target pod selected in this manner can reduce network overheads in the case of same load.

When the plurality of pods have different load, the target pod may be selected from the plurality of pods based on load of each of the plurality of pods and the weight of each pod. The manner of selecting the target pod by comprehensively considering the value of the weight of each pod and the load of each pod can balance load balancing and network overhead reduction, to improve overall performance of the load balancing cluster.

In another optional solution of the first aspect, after the selecting a target pod from the plurality of pods based on the weight of each pod, the method further includes:

directing the currently to-be-processed task in the first node to the target pod, to indicate the target pod to process the currently to-be-processed task.

According to a second aspect, this application provides a load balancing apparatus, including:

a first determining unit, configured to determine topology information of each of a plurality of smallest management units pods in a load balancing cluster to which a first node belongs, where the plurality of pods are distributed on at least two nodes;

a second determining unit, configured to determine a weight of each of the plurality of pods based on the topology information of each pod; and

a selection unit, configured to select a target pod from the plurality of pods based on the weight of each pod, where the target pod is configured to process a currently to-be-processed task in the first node.

In the foregoing apparatus, the weight of each pod is determined based on the topology information of each pod, so that a location relationship of each pod is quantized. Therefore, a value of the weight can reflect a quantity of layers of switches between a node in which each pod is located and the first node. Then a target pod spaced from the first node by a small quantity of layers of switches may be selected based on a value of the weight of each pod, to process the currently to-be-processed task in the first node, so that additional network overhead caused by selecting a pod spaced from the first node by a large quantity of layers of switches to process the currently to-be-processed task in the first node is avoided.

In another optional solution of the second aspect, the first determining unit is configured to receive the topology information of each of the plurality of pods that is sent by a control node.

In the foregoing apparatus, the first node directly receives the topology information of each of the plurality of pods that is sent by the control node, without collecting LLDP information of another computing node. This is quicker and reduces time for selecting the target pod.

In another optional solution of the second aspect, the first determining unit is configured to: collect Link Layer Discovery Protocol LLDP information of the at least two nodes; and generate the topology information of each of the plurality of pods based on the LLDP information of the at least two nodes.

In the foregoing apparatus, the first node needs to communicate with the at least two nodes, collect the LLDP information of the at least two nodes, and generate the topology information of each of the plurality of pods based on LLDP information collected in real time. The manner of generating the topology information is more accurate.

Optionally, the selection unit is configured to: when all of the plurality of pods have same load, select a pod with a smallest weight from the plurality of pods as the target pod. Because a quantity of layers of switches between the pod with the smallest weight and the first node is the smallest, the target pod selected in this manner can reduce network overheads in the case of same load.

Optionally, the selection unit is configured to: when the plurality of pods have different load, select the target pod from the plurality of pods based on load of each of the plurality of pods and the weight of each pod. The manner of selecting the target pod by comprehensively considering the value of the weight of each pod and the load of each pod can balance load balancing and network overhead reduction, to improve overall performance of the load balancing cluster.

In another optional solution of the second aspect, the apparatus further includes:

a directing unit, configured to: after the selection unit selects the target pod from the plurality of pods based on the weight of each pod, direct the currently to-be-processed task in the first node to the target pod, to indicate the target pod to process the currently to-be-processed task.

According to a third aspect, this application provides a first node. The first node includes a processor, a memory, and a communications interface, the memory is configured to store a computer program, and the processor invokes the computer program to perform the following operations:

determining topology information of each of a plurality of smallest management units pods in a load balancing cluster to which the first node belongs, where the plurality of pods are distributed on at least two nodes;

determining a weight of each of the plurality of pods based on the topology information of each pod; and

selecting a target pod from the plurality of pods based on the weight of each pod, where the target pod is configured to process a currently to-be-processed task in the first node.

In the foregoing first node, the weight of each pod is determined based on the topology information of each pod, so that a location relationship of each pod is quantized. Therefore, a value of the weight can reflect a quantity of layers of switches between a node in which each pod is located and the first node. Then a target pod spaced from the first node by a small quantity of layers of switches may be selected based on a value of the weight of each pod, to process the currently to-be-processed task in the first node, so that additional network overhead caused by selecting a pod spaced from the first node by a large quantity of layers of switches to process the currently to-be-processed task in the first node is avoided.

In another optional solution of the third aspect, when determining the topology information of each of the plurality of smallest management units pods in the load balancing cluster to which the first node belongs, the processor is configured to:

receive, by using the communications interface, the topology information of each of the plurality of pods that is sent by a control node.

In the foregoing first node, the first node directly receives the topology information of each of the plurality of pods that is sent by the control node, without collecting LLDP information of another computing node. This is quicker and reduces time for selecting the target pod.

In another optional solution of the third aspect, when determining the topology information of each of the plurality of smallest management units pods in the load balancing cluster to which the first node belongs, the processor is configured to:

collect Link Layer Discovery Protocol LLDP information of the at least two nodes; and

generate the topology information of each of the plurality of pods based on the LLDP information of the at least two nodes.

In the foregoing first node, the first node needs to communicate with the at least two nodes, collect the LLDP information of the at least two nodes, and generate the topology information of each of the plurality of pods based on LLDP information collected in real time. The manner of generating the topology information is more accurate.

In another optional solution of the third aspect, when selecting the target pod from the plurality of pods based on the weight of each pod, the processor is configured to:

when all of the plurality of pods have same load, select a pod with a smallest weight from the plurality of pods as the target pod, where because a quantity of layers of switches between the pod with the smallest weight and the first node is the smallest, the target pod selected in this manner can reduce network overheads in the case of same load; or

when the plurality of pods have different load, select the target pod from the plurality of pods based on load of each of the plurality of pods and the weight of each pod, where the manner of selecting the target pod by comprehensively considering the value of the weight of each pod and the load of each pod can balance load balancing and network overhead reduction, to improve overall performance of the load balancing cluster.

In another optional solution of the third aspect, the processor is further configured to:

after selecting the target pod from the plurality of pods based on the weight of each pod, direct the currently to-be-processed task in the first node to the target pod, to indicate the target pod to process the currently to-be-processed task.

With reference to any one of the foregoing aspects or any optional solution of any one of the foregoing aspects, in another optional solution, the load balancing cluster includes the control node and at least two computing nodes, the first node is one of the at least two computing nodes, the control node is configured to manage the at least two computing nodes, and the plurality of pods are distributed on the at least two computing nodes.

With reference to any one of the foregoing aspects or any optional solution of any one of the foregoing aspects, in another optional solution,

a weight of a pod in the first node is a first weight;

a weight of a pod in a second node is a second weight, where the second node and the first node are connected to a same top-of-rack switch, and an Internet Protocol IP address of the second node and an IP address of the first node belong to a same network segment;

a weight of a pod in a third node is a third weight, where the third node and the first node are connected to different top-of-rack switches, and the different top-of-rack switches are connected to a same leaf switch;

a weight of a pod in a fourth node is a fourth weight, where the fourth node and the first node are connected to different leaf switches, and the different leaf switches are connected to a same spine switch; and

first weight<second weight<third weight<fourth weight.

According to a fourth aspect, this application provides a computer-readable storage medium. The computer-readable storage medium stores a computer program, and when being executed by a processor, the computer program enables the processor to implement the method described in any one of the first aspect and the optional solutions of the first aspect.

In this application, the weight of each pod is determined based on the topology information of each pod, so that a location relationship of each pod is quantized. Therefore, a value of the weight can reflect a quantity of layers of switches between a node in which each pod is located and the first node. Then a target pod spaced from the first node by a small quantity of layers of switches may be selected based on a value of the weight of each pod, to process the currently to-be-processed task in the first node, so that additional network overhead caused by selecting a pod spaced from the first node by a large quantity of layers of switches to process the currently to-be-processed task in the first node is avoided.

### BRIEF DESCRIPTION OF DRAWINGS

FIG. 1 is a schematic diagram of an architecture of a load balancing cluster according to an embodiment of this application;

FIG. 2 is a schematic diagram of a process of allocating a task request according to an embodiment of this application;

FIG. 3 is a schematic flowchart of a load balancing method according to an embodiment of this application;

FIG. 4 is a schematic diagram of topology information of each of a plurality of pods in a plurality of nodes according to an embodiment of this application;

FIG. 5 is a schematic diagram of sending topology information of each of a plurality of pods in a plurality of nodes to a first node by a control node according to an embodiment of this application;

FIG. 6 is a schematic diagram of generating topology information of each pod in a node 1 and a node 2 by the node 1 based on LLDP information of the node 1 and the node 2 according to an embodiment of this application;

FIG. 7 is a schematic diagram of a structure of a load balancing apparatus according to an embodiment of this application; and

FIG. 8 is a schematic diagram of a structure of another load balancing apparatus according to an embodiment of this application.

### DESCRIPTION OF EMBODIMENTS

The following describes embodiments of this application with reference to the accompanying drawings in embodiments of this application.

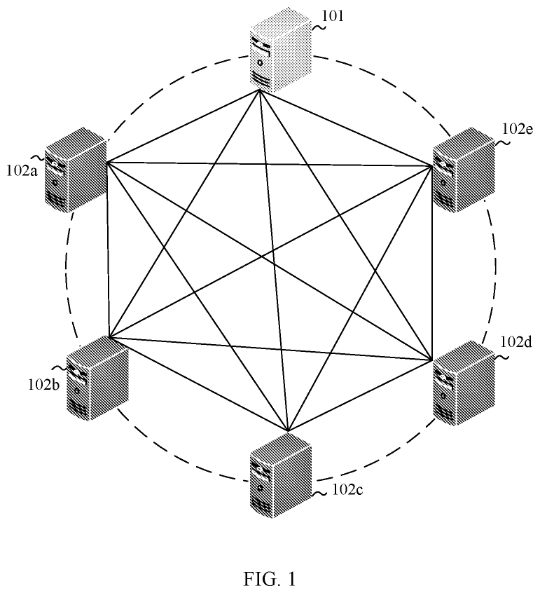

FIG. 1 is a schematic diagram of an architecture of a load balancing cluster according to an embodiment of this application. The load balancing cluster may include one control node 101 and at least two computing nodes 102 (102a to 102e are shown in the figure). Each of the control node 101 and the at least two computing nodes 102 may be one server or one virtual machine on a cloud platform. The control node 101 is configured to manage the at least two computing nodes 102. The at least two computing nodes 102 are load balancing nodes, and are configured to select a pod from the computing nodes to process a to-be-processed task. For example, the to-be-processed task may be a request of opening video software or a request of accessing a website. Each computing node may include one or more smallest management units pods.

The load balancing cluster may be a container orchestration and management platform (for example, Kubernetes, k8s) cluster or a cluster in another running environment. Kubernetes is an open source platform for scheduling containers across host clusters. Kubernetes can enable a containerized application to be deployed simply and efficiently, and provides a mechanism for application deployment, planning, updating, and maintenance. In a conventional application deployment manner, an application is installed by using a plug-in or a script. A disadvantage of this is that running, configuration, management, and a lifecycle of the application are bound to a current operating system. This is not conducive to an operation such as upgrading and updating/rollback of the application. Certainly, some functions may be implemented by creating a virtual machine. However, the virtual machine is quite heavy, and is not conducive to portability. When containers are deployed by using Kubernetes, the containers are isolated from each other, the containers have respective file systems, processes between the containers do not affect each other, and computing resources can be distinguished. Compared with the virtual machine, the container can be quickly deployed. Because the container is decoupled from an underlying facility and a machine file system, the container can be migrated between operating systems of different clouds and versions.

A pod is a smallest management unit in a Kubernetes cluster, is a smallest component created or deployed by a user, and is also a resource object used when a containerized application runs on the Kubernetes cluster. A unique IP address is assigned to each pod, each pod includes one or more containers, and containers in a same pod are allocated to a same node. Containers inside the pod share network space of the pod, including an IP address and a port. The containers inside the pod can communicate with each other by using a host machine of the pod. When the container inside the pod communicates with the outside, a network resource allocated to the pod needs to be used.

The containers inside the pod can access a shared volume. The volume may also be used to persist a storage resource in the pod to prevent file loss after the container is restarted. The containers inside the pod are always scheduled at the same time and have a common running environment.

When a client requests a service, a server selects a target pod in the load balancing cluster by using a load balancing scheduling algorithm, and the target pod serves the client. The load balancing scheduling algorithm includes a static scheduling algorithm and a dynamic scheduling algorithm. The following briefly describes the static scheduling algorithm and the dynamic scheduling algorithm.

Static scheduling algorithm: A service request is allocated according to a specified algorithm regardless of a quantity of real-time connections.

For example, a round robin (RR) algorithm is used to sequentially allocate external requests to nodes in the cluster in turn. In the algorithm, the nodes are equally treated regardless of actual quantities of connections and load on the nodes.

For another example, a weighted round robin (WRR) algorithm is used to allocate one weight to each node in the cluster. A larger weight indicates a larger quantity of allocated requests.

For another example, a destination hashing (DH) algorithm is used to find a corresponding node from a statically allocated hash table by using a destination IP address of a request as a hash key. If the node is available and is not overloaded, the request is sent to the node; otherwise, null is returned. Requests from a same IP address are redirected to a same node to ensure that a destination address remains unchanged.

For another example, a source hashing (SH) algorithm is used to find a corresponding node from a statically allocated hash table by using a source IP address of a request as a hash key. If the node is available and is not overloaded, the request is sent to the node; otherwise, null is returned.

Dynamic scheduling algorithm: A manner of next scheduling is re-determined by checking an activity status of a current quantity of connections on a node.

For example, a least connection (LC) algorithm is used, in other words, a next connection request is directed to a node with a small quantity of connections. The algorithm is implemented as follows: Quantity of connections=Quantity of active connections*256+Quantity of inactive connections.

For another example, a weighted least connection (WLC) algorithm is used, in other words, one weight is allocated to each node based on least connections. The algorithm is implemented as follows: Quantity of connections=(Quantity of active connections*256+Quantity of inactive connections)-Weight. The algorithm is a relatively ideal algorithm.

For another example, a shortest expected delay (SED) algorithm is used, in other words, a quantity of inactive connections is no longer considered. The algorithm is implemented as follows: Quantity of connections=(Quantity of active connections+1)*256±Weight.

For another example, a never queue (NQ) algorithm is used. The never queue algorithm is an improvement of the SED algorithm. When a new request arrives, allocation of the new request depends not only on a value obtained by the SED algorithm, but also on whether an active connection exists on a node.

For another example, a locality-based least connection (locality-based least-connection, LBLC) algorithm is used, in other words, a quantity of active connections on a node is further considered based on the DH algorithm.

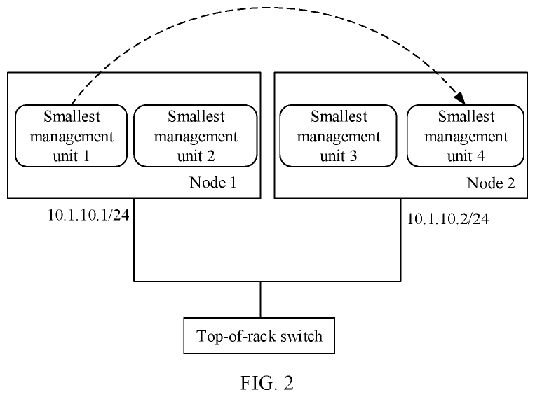

In a container network scenario, load balancing in a container orchestration and management platform is implemented by deploying distributed software on nodes in a load balancing cluster. The manner of allocating a task request according to a scheduling algorithm by using the distributed software is prone to cause additional network overheads. FIG. 2 is a schematic diagram of a process of allocating a task request. A smallest management unit pod 1 in a node 1 is a client that initiates a request. The node 1 and a node 2 are connected to a same top-of-rack switch. The node 1 allocates the task request to a pod 4 in the node 2, and the pod 4 actually provides a service. The task request is not allocated to a pod 2 in the node 1, causing additional network overheads. To resolve the foregoing technical problems, embodiments of this application provide the following solutions.

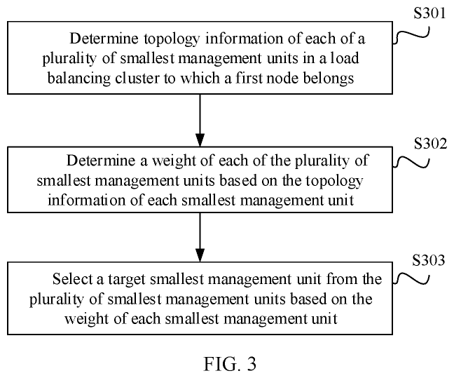

FIG. 3 shows a load balancing method according to an embodiment of this application. The method may be implemented based on the load balancing cluster shown in FIG. 1. The method includes but is not limited to the following steps.

Step S301: A first node determines topology information of each of a plurality of smallest management units pods in a load balancing cluster to which the first node belongs.

The first node is a node, for example, a computing node, in the load balancing cluster. The plurality of pods are distributed on at least two nodes in the load balancing cluster. For example, some are distributed on the first node, some are distributed on a node connected to a same top-of-rack switch as the first node, some are distributed on a node connected to a same leaf switch as the first node, and some are distributed on a node connected to a same spine switch as the first node. A quantity of pods distributed on each of the at least two nodes is not limited herein. The plurality of pods can process a currently to-be-processed task in the first node. The topology information of each pod represents a node in which the pod is located and a connection relationship between the node in which the pod is located and another node.

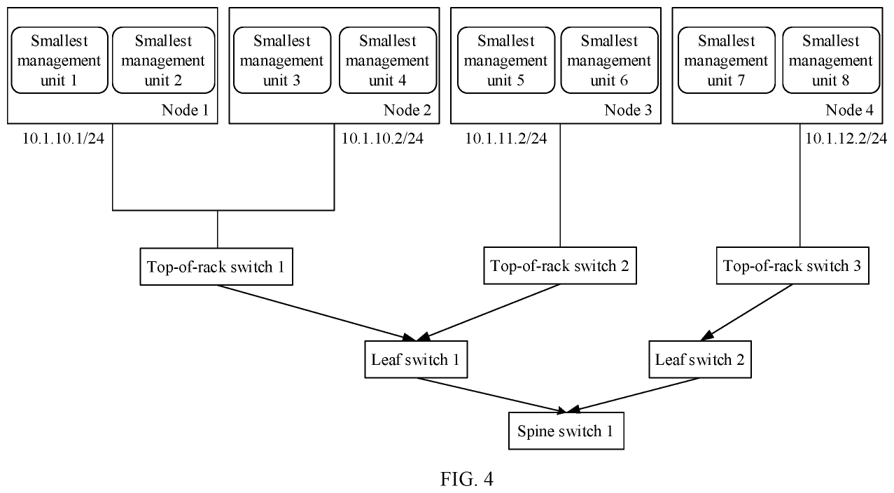

It is assumed that a node 1 includes a pod 1 and a pod 2, a node 2 includes a pod 3 and a pod 4, a node 3 includes a pod 5 and a pod 6, a node 4 includes a pod 7 and a pod 8, the node 1 is the first node, the pod 1 in the node 1 is a client that initiates a request, both the pod 3 and the pod 4 in the node 2 can provide services for the request, both the pod 5 and the pod 6 in the node 3 can provide services for the request, and both the pod 7 and the pod 8 in the node 4 can also provide services for the request. In this case, the node 1 determines, based on an Internet Protocol IP address 10.1.10.2 of the node 2, that the node 2 and the node 1 belong to a same network segment and are connected to a same top-of-rack switch. The node 1 determines, based on an IP address 10.1.11.2 of the node 3, that the node 3 is connected to a top-of-rack switch 2, the node 1 is connected to a top-of-rack switch 1, and the top-of-rack switch 1 and the top-of-rack switch 2 are connected to a same leaf switch 1. The node 1 determines, based on an IP address 10.1.12.2 of the node 4, that the node 4 is connected to a top-of-rack switch 3, the top-of-rack switch 3 is connected to a leaf switch 2, the node 1 is connected to the top-of-rack switch 1, the top-of-rack switch 1 is connected to the leaf switch 1, and the leaf switch 1 and the leaf switch 2 are connected to a same spine switch 1. Topology information of each of the plurality of nodes that is finally determined by the node 1 may be shown in FIG. 4.

Manners of determining the topology information of each of the plurality of pods in the load balancing cluster include but are not limited to the following two manners:

Manner 1: The topology information of each of the plurality of pods that is sent by a control node is received.

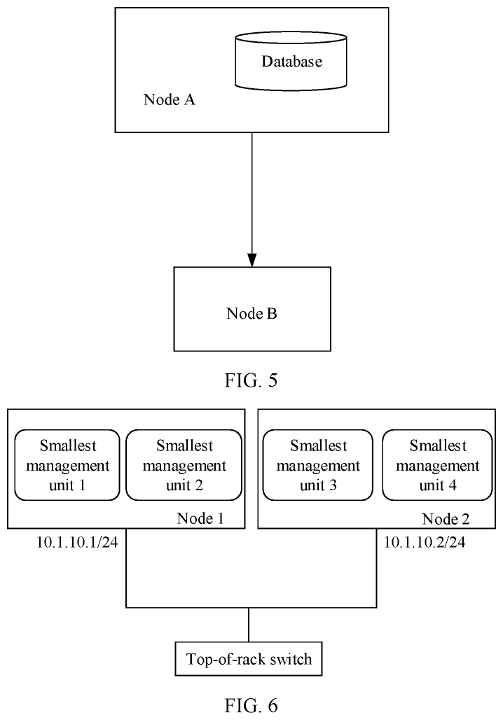

For example, FIG. 5 shows a process in which the control node sends the topology information of each of the plurality of pods in the plurality of nodes to the first node. A node A is the control node, and a node B is the first node. When the load balancing cluster is deployed, a default distributed key value database (etcd) stores a deployment status of each computing node and a deployment status of a pod in each computing node. Optionally, a user may define how each node in the load balancing cluster and a pod in the node are deployed. Optionally, when a new pod is added, an existing pod is deleted, or corresponding information of a pod is updated, related information is updated to the control node in real time. The control node sends the topology information of each of the plurality of pods in the plurality of nodes to the first node, and correspondingly, the first node receives the topology information of each of the plurality of pods.

Manner 2: Link Layer Discovery Protocol (LLDP) information of the at least two nodes is collected, and then the topology information of each of the plurality of pods is generated based on the LLDP information of the at least two nodes.

The collection herein may be active reading or passive reception. In a first case, when the collection is active reading, the first node sends a request message to the plurality of nodes separately or in a multicast manner to request LLDP information. After receiving the request message, each of the plurality of nodes sends LLDP information of the node to the first node. In a second case, when the collection is passive reception, each of the plurality of nodes periodically sends LLDP information of the node to the first node, and correspondingly, the first node receives the LLDP information sent by the plurality of nodes.

The LLDP information may include information used to identify the node and information used to identify a peer end of the node. For example, the information used to identify the node includes a node identifier (namely, a chassis ID) and a port identifier (port ID) of the node, and the information used to identify the peer end of the node includes a chassis ID and a port ID of the peer end. A connection relationship between the node and another node may be determined based on the chassis ID and the port ID that are used for the node and the chassis ID and the port ID of the peer end of the node.

For example, there is a node 1 and a node 2 (each node uses a MAC address of the node as a node identifier and a port name of the node as a port identifier), the node 1 is the first node, a node identifier of the node 1 is chassis ID=00-16-EA-AE-3C-40, a port identifier of a port a of the node 1 is port ID=Ethernet 0/0/7/0, a node identifier of the node 2 is chassis ID=00-16-EA-AE-2B-66, and a port identifier of a port b of the node 2 is port ID=Ethernet 0/0/6/0. In this case, information about the node 1 in collected LLDP information of the node 1 includes chassis ID=00-16-EA-AE-3C-40 and port ID=Ethernet 0/0/7/0, and information about a peer end includes chassis ID=00-16-EA-AE-2B-66 and port ID=Ethernet 0/0/6/0. Information about the node 2 in collected LLDP information of the node 2 includes chassis ID=00-16-EA-AE-2B-66 and port ID=Ethernet 0/0/6/0, and information about a peer end includes chassis ID=00-16-EA-AE-3C-40 and port ID=Ethernet 0/0/7/0. It is determined, based on the LLDP information of the node 1 and the LLDP information of the node 2, that a connection relationship exists between the port a of the node 1 and the port b of the node 2, in other words, it is determined that the node 1 and the node 2 are connected to a same top-of-rack switch. Because the node 1 includes a pod 2, the node 2 includes a pod 3 and a pod 4, and the like, topology information of each pod in the node 1 and the node 2 that is finally generated by the node 1 based on the LLDP information of the node 1 and the node 2 may be shown in FIG. 6.

Step S302: The first node determines a weight of each of the plurality of pods based on the topology information of each pod.

Optionally, the weight of each pod may be configured according to the following rule:

A weight of a pod in the first node is a first weight;

a weight of a pod in a second node is a second weight, where the second node and the first node are connected to a same top-of-rack switch, and an Internet Protocol IP address of the second node and an IP address of the first node belong to a same network segment;

a weight of a pod in a third node is a third weight, where the third node and the first node are connected to different top-of-rack switches, and the different top-of-rack switches are connected to a same leaf switch; and

a weight of a pod in a fourth node is a fourth weight, where the fourth node and the first node are connected to different leaf switches, and the different leaf switches are connected to a same spine switch.

In an implementation, first weight<second weight<third weight<fourth weight. In this implementation, a larger weight indicates higher calculated overheads and a smaller probability of selecting a pod related to the overheads.

In another implementation, first weight>second weight>third weight>fourth weight. In this implementation, a larger weight indicates lower calculated overheads and a larger probability of selecting a pod related to the overheads.

The top-of-rack switch is usually a switch directly connected to a node. The leaf switch connects different top-of-rack switches, is a convergence point of a plurality of top-of-rack switches, and can process all communication coming from the top-of-rack switches and provide the communication to the spine switch. The spine switch connects different leaf switches, and can forward communication at a high speed.

For example, as shown in FIG. 4, if a node 1 is the first node, because both a pod 2 and a pod 1 are located in the node 1, it may be determined that a weight of the pod 2 is a first weight. The first weight may be 4. Because a node 2 and the node 1 are connected to a same top-of-rack switch 1, and IP addresses of the node 2 and the node 1 belong to a same network segment, it may be determined that a weight of each of a pod 3 and a pod 4 in the node 2 is a second weight. For example, the second weight may be 5. Because a node 3 is connected to a top-of-rack switch 2, the node 1 is connected to the top-of-rack switch 1, and the top-of-rack switch 1 and the top-of-rack switch 2 are connected to a same leaf switch 1, it may be determined that a weight of each of a pod 5 and a pod 6 in the node 3 is a third weight. For example, the third weight may be 6. Because a node 4 is connected to a top-of-rack switch 3, the node 1 is connected to the top-of-rack switch 1, the top-of-rack switch 3 is connected to a leaf switch 2, the top-of-rack switch 1 is connected to the leaf switch 1, and the leaf switch 1 and the leaf switch 2 are connected to a same spine switch 1, it may be determined that a weight of each of a pod 7 and a pod 8 in the node 4 is a fourth weight. For example, the fourth weight may be 7.

Step S303: The first node selects a target pod from the plurality of pods based on the weight of each pod.

The first node selects a pod with a smallest weight from the plurality of pods as the target pod based on a value of the weight of each pod. The target pod is one of the plurality of pods, and the target pod is configured to process the currently to-be-processed task in the first node. Optionally, when there are a plurality of pods with a smallest weight, further selection may be performed on the plurality of pods with the smallest weight, so that one of the plurality of pods is selected as the target pod.

For example, still as shown in FIG. 4, if the weight of the pod 2 in the node 1 (namely, the first node) is 4, the weight of each of the pod 3 and the pod 4 in the node 2 is 5, the weight of each of the pod 5 and the pod 6 in the node 3 is 6, and the weight of each of the pod 7 and the pod 8 in the node 4 is 7, because 4<5<6<7, the first node selects the pod 2 to process the currently to-be-processed task. For example, the pod 2 responds to a request of opening video software, to provide a corresponding service.

In an optional solution, the selecting a target pod from the plurality of pods based on the weight of each pod may be: when all of the plurality of pods have same load, selecting a pod with a smallest weight from the plurality of pods as the target pod. The load of the pod represents usage of one or more resources, for example, a central processing unit (CPU), memory, and bandwidth, of a node in which the pod is located.

For example, the load is CPU usage. If CPU usage of the node 1 in which the pod 2 is located is 50%, CPU usage of the node 2 in which the pod 3 and the pod 4 are located is 50%, CPU usage of the node 3 in which the pod 5 and the pod 6 are located is 50%, CPU usage of the node 4 in which the pod 7 and the pod 8 are located is 50%, the weight of the pod 2 is 4, the weight of each of the pod 3 and the pod 4 is 5, the weight of each of the pod 5 and the pod 6 is 6, and the weight of each of the pod 7 and the pod 8 is 7, because 4<5<6<7, the first node selects the pod 2 with the smallest weight from the plurality of pods as the target pod.

In an optional solution, the selecting a target pod from the plurality of pods based on the weight of each pod may be: when the plurality of pods have different load, selecting the target pod based on load of each of the plurality of pods and the weight of each pod.

Optionally, training may be performed in advance based on a plurality of data records (where each data record includes one load value, one weight, and one pod), to obtain a recommendation model that can represent a correspondence between both load and a weight and a target pod, and then the load and the weight of each pod that are obtained in real time in this embodiment of this application may be input into the recommendation model, to recommend a target pod by using the recommendation model. The recommended target pod is the target pod selected in this application.

Optionally, a corresponding policy may be further preconfigured. A pod is finally selected as the target pod by comprehensively considering impact of load and a weight based on the policy.

Optionally, a corresponding algorithm may also be preconfigured. The load and the weight of each pod are substituted into the algorithm, to output a value representing a selection tendency of each pod, and then a pod is selected as the target pod based on the value representing the selection tendency of each pod. It is assumed that when CPU usage of a node is 10%, an impact factor of a pod in the node is 1; when CPU usage of anode is 20%, an impact factor of a pod in the node is 2; when CPU usage of a node is 30%, an impact factor of a pod in the node is 3; and when CPU usage of a node is 40%, an impact factor of a pod in the node is 4. If CPU usage of the node 1 in which the pod 2 is located is 10%, in other words, an impact factor of the pod 2 is 1, CPU usage of the node 2 in which the pod 3 and the pod 4 are located is 20%, in other words, an impact factor of each of the pod 3 and the pod 4 is 2, CPU usage of the node 3 in which the pod 5 and the pod 6 are located is 30%, in other words, an impact factor of each of the pod 5 and the pod 6 is 3, and CPU usage of the node 4 in which the pod 7 and the pod 8 are located is 40%, in other words, an impact factor of each of the pod 7 and the pod 8 is 4, because the weight of the pod 2 is 4, the weight of each of the pod 3 and the pod 4 is 5, the weight of each of the pod 5 and the pod 6 is 6, and the weight of each of the pod 7 and the pod 8 is 7, the first node selects, as the target pod, a pod for which a sum of a weight and an impact factor is the smallest. A sum of the impact factor and the weight of the pod 2 is 5, a sum of the impact factor and the weight of the pod 3 is 7 (the same is true for the pod 4), a sum of the impact factor and the weight of the pod 5 is 9 (the same is true for the pod 6), and a sum of the impact factor and the weight of the pod 7 is 11 (the same is true for the pod 8). Optionally, there is a stronger tendency to select a pod for which a sum of an impact factor and a weight is smaller. Because 5<7<9<11, the first node selects the pod 2 as the target pod. If sums of impact factors and weights of the pods are the same, the first node selects a pod with a relatively small weight as the target pod.

Only the CPU usage of the node in which the pod is located is used as the load of the pod above. When usage of a plurality of resources of the node in which the pod is located is used as the load of the pod, a person skilled in the art can design a plurality of different algorithms to determine comprehensive usage of the plurality of resources of the node, and use the comprehensive usage as the load of the pod.

In an optional solution, before the topology information of each of the plurality of smallest management units pods in the load balancing cluster to which the first node belongs is determined, a request of a task that needs to be processed in the first node may be directed to the plurality of pods in the load balancing cluster by using a round robin algorithm.

For example, if the request of the task that needs to be processed in the first node may be opening video software, and the plurality of pods in the load balancing cluster can provide services for the request of opening the video software, the first node directs the request of opening the video software to a pod in the load balancing cluster based on the round robin algorithm, and the pod responds to the request directed to the pod, to provide a corresponding service.

Optionally, after selecting the target pod from the plurality of pods based on the weight of each pod, the first node may direct the currently to-be-processed task in the first node to the target pod, to indicate the target pod to execute the currently to-be-processed task. For example, the to-be-processed task may be a request of opening video software or a request of accessing a website.

In the method described in FIG. 3, the weight of each pod is determined based on the topology information of each pod, so that a location relationship of each pod is quantized. Therefore, a value of the weight can reflect a quantity of layers of switches between a node in which each pod is located and the first node. Then a target pod spaced from the first node by a small quantity of layers of switches may be selected based on a value of the weight of each pod, to process the currently to-be-processed task in the first node, so that a pod spaced from the first node by a large quantity of layers of switches is prevented from being selected to process the currently to-be-processed task in the first node, thereby reducing network overheads.

The methods in embodiments of this application are described in detail above. Apparatuses in embodiments of this application are provided below.

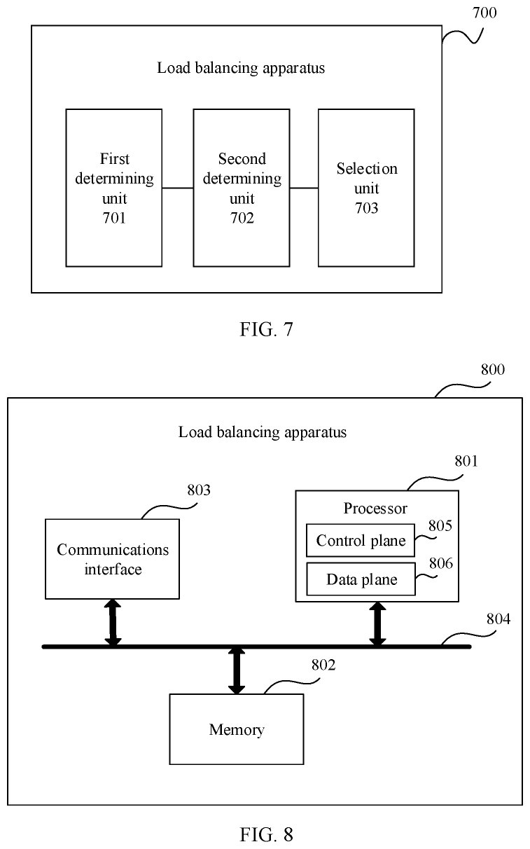

FIG. 7 is a schematic diagram of a structure of a load balancing apparatus according to an embodiment of this application. The load balancing apparatus may be the foregoing first node or a component in the first node. The load balancing apparatus 700 may include a first determining unit 701, a second determining unit 702, and a selection unit 703.

The first determining unit 701 is configured to determine topology information of each of a plurality of smallest management units pods in a load balancing cluster to which the first node belongs. The plurality of pods are distributed on at least two nodes.

The second determining unit 702 is configured to determine a weight of each of the plurality of pods based on the topology information of each pod.

The selection unit 703 is configured to select a target pod from the plurality of pods based on the weight of each pod. The target pod is configured to process a currently to-be-processed task in the first node.

In the foregoing apparatus, the weight of each pod is determined based on the topology information of each pod, so that a location relationship of each pod is quantized. Therefore, a value of the weight can reflect a quantity of layers of switches between a node in which each pod is located and the first node. Then a target pod spaced from the first node by a small quantity of layers of switches may be selected based on a value of the weight of each pod, to process the currently to-be-processed task in the first node, so that a pod spaced from the first node by a large quantity of layers of switches is prevented from being selected to process the currently to-be-processed task in the first node, thereby reducing network overheads.

In an optional solution, the load balancing cluster includes a control node and at least two computing nodes, the first node is one of the at least two computing nodes, the control node is configured to manage the at least two computing nodes, and the plurality of pods are distributed on the at least two computing nodes.

In another optional solution, the first determining unit 701 is configured to receive the topology information of each of the plurality of pods that is sent by the control node.

In the foregoing apparatus, the first node directly receives the topology information of each of the plurality of pods that is sent by the control node, without collecting LLDP information of another computing node. This is quicker and reduces time for selecting the target pod.

In another optional solution, the first determining unit 701 is configured to: collect Link Layer Discovery Protocol (LLDP) information of the at least two nodes; and generate the topology information of each of the plurality of pods based on the LLDP information of the at least two nodes.

In the foregoing apparatus, the first node needs to communicate with the at least two nodes, collect the LLDP information of the at least two nodes, and generate the topology information of each of the plurality of pods based on LLDP information collected in real time. The manner of generating the topology information is more accurate.

In another optional solution,

a weight of a pod in the first node is a first weight;

a weight of a pod in a second node is a second weight, where the second node and the first node are connected to a same top-of-rack switch, and an Internet Protocol IP address of the second node and an IP address of the first node belong to a same network segment;

a weight of a pod in a third node is a third weight, where the third node and the first node are connected to different top-of-rack switches, and the different top-of-rack switches are connected to a same leaf switch; and

a weight of a pod in a fourth node is a fourth weight, where the fourth node and the first node are connected to different leaf switches, and the different leaf switches are connected to a same spine switch.

In an implementation, first weight<second weight<third weight<fourth weight. In this implementation, a larger weight indicates higher calculated overheads and a smaller probability of selecting a pod related to the overheads.

In another implementation, first weight>second weight>third weight>fourth weight. In this implementation, a larger weight indicates lower calculated overheads and a larger probability of selecting a pod related to the overheads.

In another optional solution, the selection unit 703 is configured to: when all of the plurality of pods have same load, select a pod with a smallest weight from the plurality of pods as the target pod. Because a quantity of layers of switches between the pod with the smallest weight and the first node is the smallest, the target pod selected in this manner can reduce network overheads in the case of same load.

In another optional solution, the selection unit 703 is configured to: when the plurality of pods have different load, select the target pod from the plurality of pods based on load of each of the plurality of pods and the weight of each pod. The manner of selecting the target pod by comprehensively considering the value of the weight of each pod and the load of each pod can balance load balancing and network overhead reduction, to improve overall performance of the load balancing cluster.

In another optional solution, the apparatus further includes a directing unit, and the directing unit is configured to: after the selection unit 703 selects the target pod from the plurality of pods based on the weight of each pod, direct the currently to-be-processed task in the first node to the target pod, to indicate the target pod to process the currently to-be-processed task.

It should be noted that for implementation of the units, refer to corresponding descriptions in the method embodiment shown in FIG. 3.

FIG. 8 shows another load balancing apparatus 800 according to an embodiment of this application. The load balancing apparatus may be the first node in the foregoing implementations or a virtual machine in the first node. The load balancing apparatus 800 includes a processor 801, a memory 802, and a communications interface 803. The processor 801 includes a control plane 805 and a data plane 806. The processor 801, the memory 802, and the communications interface 803 are connected to each other by using a bus 804.

The memory 802 includes but is not limited to a random access memory (RAM), a read-only memory (ROM), an erasable programmable read-only memory (EPROM), or a compact disc read-only memory (CD-ROM). The memory 802 is configured to store program instructions and data. The communications interface 803 is configured to send and receive data.

The processor 801 may be one or more central processing units (CPU). When the processor 801 is one CPU, the CPU may be a single-core CPU or a multi-core CPU.

The processor 801 in the load balancing apparatus 800 invokes the computer program stored in the memory 802 to perform the following operations:

determining, by using the control plane 805, topology information of each of a plurality of smallest management units pods in a load balancing cluster to which the first node belongs, where the plurality of pods are distributed on at least two nodes;

determining, by using the control plane 805, a weight of each of the plurality of pods based on the topology information of each pod; and

selecting, by using the data plane 806, a target pod from the plurality of pods based on the weight of each pod, where the target pod is configured to process a currently to-be-processed task in the first node.

In the foregoing load balancing apparatus, the weight of each pod is determined based on the topology information of each pod, so that a location relationship of each pod is quantized. Therefore, a value of the weight can reflect a quantity of layers of switches between a node in which each pod is located and the first node. Then a target pod spaced from the first node by a small quantity of layers of switches may be selected based on a value of the weight of each pod, to process the currently to-be-processed task in the first node, so that a pod spaced from the first node by a large quantity of layers of switches is prevented from being selected to process the currently to-be-processed task in the first node, thereby reducing network overheads.

In an optional solution, the load balancing cluster includes a control node and at least two computing nodes, the first node is one of the at least two computing nodes, the control node is configured to manage the at least two computing nodes, and the plurality of pods are distributed on the at least two computing nodes.

In another optional solution, the processor 801 is configured to:

receive, by using the communications interface 803, the topology information of each of the plurality of pods that is sent by the control node.

In this way, the load balancing apparatus directly receives the topology information of each of the plurality of pods that is sent by the control node, without collecting LLDP information of another computing node. This is quicker and reduces time for selecting the target pod.

In another optional solution, the processor 801 is configured to:

collect Link Layer Discovery Protocol (LLDP) information of the at least two nodes; and

generate the topology information of each of the plurality of pods based on the LLDP information of the at least two nodes.

In this way, the load balancing apparatus needs to communicate with the at least two nodes, collect the LLDP information of the at least two nodes, and generate the topology information of each of the plurality of pods based on LLDP information collected in real time. The manner of generating the topology information is more accurate.

Optionally, a weight of a pod in the first node is a first weight; a weight of a pod in a second node is a second weight, where the second node and the first node are connected to a same top-of-rack switch, and an Internet Protocol (IP) address of the second node and an IP address of the first node belong to a same network segment; a weight of a pod in a third node is a third weight, where the third node and the first node are connected to different top-of-rack switches, and the different top-of-rack switches are connected to a same leaf switch; and a weight of a pod in a fourth node is a fourth weight, where the fourth node and the first node are connected to different leaf switches, and the different leaf switches are connected to a same spine switch.

In an implementation, first weight<second weight<third weight<fourth weight. In this implementation, a larger weight indicates higher calculated overheads and a smaller probability of selecting a pod related to the overheads.

In another implementation, first weight>second weight>third weight>fourth weight. In this implementation, a larger weight indicates lower calculated overheads and a larger probability of selecting a pod related to the overheads.

In another optional solution, when selecting the target pod from the plurality of pods based on the weight of each pod, the processor 801 is configured to:

when all of the plurality of pods have same load, select a pod with a smallest weight from the plurality of pods as the target pod, where because a quantity of layers of switches between the pod with the smallest weight and the first node is the smallest, the target pod selected in this manner can reduce network overheads in the case of same load; or

when the plurality of pods have different load, select the target pod from the plurality of pods based on load of each of the plurality of pods and the weight of each pod, where the manner of selecting the target pod by comprehensively considering the value of the weight of each pod and the load of each pod can balance load balancing and network overhead reduction, to improve overall performance of the load balancing cluster.

In another optional solution, the processor 801 is further configured to:

after selecting the target pod from the plurality of pods based on the weight of each pod, direct the currently to-be-processed task in the first node to the target pod, to indicate the target pod to process the currently to-be-processed task.

It should be noted that for implementation of each operation, refer to corresponding descriptions in the method embodiment shown in FIG. 3.

An embodiment of this application further provides a computer-readable storage medium. The computer-readable storage medium stores a computer program, and when the computer program runs on a processor, the method shown in FIG. 3 is implemented.

An embodiment of the present application further provides a computer program product. When the computer program product is run on a processor, the method embodiment shown in FIG. 3 is implemented.

A person of ordinary skill in the art may understand that all or some of the procedures of the methods in the embodiments may be implemented by a computer program or a computer program driving related hardware. The computer program may be stored in a computer-readable storage medium, and when the program is executed, the procedures of the foregoing method embodiments may be implemented. The foregoing storage medium includes any medium that can store computer program code, such as a ROM, a random access memory RAM, a magnetic disk, or an optical disk.

1. A load balancing method, comprising:
determining topology information of each of a plurality of smallest management units pods in a load balancing cluster to which a first node belongs, wherein the plurality of pods are distributed on at least two nodes;
determining a weight of each of the plurality of pods based on the topology information of each pod; and
selecting a target pod from the plurality of pods based on the weight of each pod, wherein the target pod is configured to process a currently to-be-processed task in the first node.

2. The method according to claim 1, wherein the load balancing cluster comprises a control node and at least two computing nodes, the first node is one of the at least two computing nodes, the control node is configured to manage the at least two computing nodes, and the plurality of pods are distributed on the at least two computing nodes.

3. The method according to claim 2, wherein the determining topology information of each of the plurality of smallest management units pods in the load balancing cluster to which the first node belongs comprises:
receiving the topology information of each of the plurality of pods that is sent by the control node.

4. The method according to claim 1, wherein the determining topology information of each of the plurality of smallest management units pods in the load balancing cluster to which the first node belongs comprises:
collecting Link Layer Discovery Protocol (LLDP) information of the at least two nodes; and
generating the topology information of each of the plurality of pods based on the LLDP information of the at least two nodes.

5. The method according to claim 1, wherein
a weight of a pod in the first node is a first weight;
a weight of a pod in a second node is a second weight, wherein the second node and the first node are connected to a same top-of-rack switch, and wherein an Internet Protocol (IP) address of the second node and an IP address of the first node belong to a same network segment;
a weight of a pod in a third node is a third weight, wherein the third node and the first node are connected to different top-of-rack switches, and wherein the different top-of-rack switches are connected to a same leaf switch; and
a weight of a pod in a fourth node is a fourth weight, wherein the fourth node and the first node are connected to different leaf switches, and wherein the different leaf switches are connected to a same spine switch.

6. The method according claim 1, wherein the selecting the target pod from the plurality of pods based on the weight of each pod comprises:
in response to all of the plurality of pods having a same load, selecting a pod with a smallest weight from the plurality of pods as the target pod; or
in response to the plurality of pods having a different load, selecting the target pod from the plurality of pods based on the load of each of the plurality of pods and the weight of each pod.

7. The method according to claim 1, wherein after the selecting the target pod from the plurality of pods based on the weight of each pod, the method further comprises:
directing the currently to-be-processed task in the first node to the target pod to indicate the target pod is to process the currently to-be-processed task.

8. The method according to claim 1, wherein the load balancing cluster is deployed by using Kubernetes platform.

9. A first node, comprising a processor, a memory, and a communications interface, the memory is configured to store a computer program, and the processor is configured to invoke the computer program to:
determine topology information of each of a plurality of smallest management units pods in a load balancing cluster to which the first node belongs, wherein the plurality of pods are distributed on at least two nodes;
determine a weight of each of the plurality of pods based on the topology information of each pod; and
select a target pod from the plurality of pods based on the weight of each pod, wherein the target pod is configured to process a currently to-be-processed task in the first node.

10. The first node according to claim 9, wherein the load balancing cluster comprises a control node and at least two computing nodes, the first node is one of the at least two computing nodes, the control node is configured to manage the at least two computing nodes, and the plurality of pods are distributed on the at least two computing nodes.

11. The first node according to claim 10, wherein the processor is configured to invoke the computer program to receive the topology information of each of the plurality of pods that is sent by the control node.

12. The first node according to claim 9, wherein the processor is configured to invoke the computer program to:
collect Link Layer Discovery Protocol (LLDP) information of the at least two nodes; and
generate the topology information of each of the plurality of pods based on the LLDP information of the at least two nodes.

13. The first node according to any claim 9, wherein
a weight of a pod in the first node is a first weight;
a weight of a pod in a second node is a second weight, wherein the second node and the first node are connected to a same top-of-rack switch, and wherein an Internet Protocol (IP) address of the second node and an IP address of the first node belong to a same network segment;
a weight of a pod in a third node is a third weight, wherein the third node and the first node are connected to different top-of-rack switches, and wherein the different top-of-rack switches are connected to a same leaf switch; and
a weight of a pod in a fourth node is a fourth weight, wherein the fourth node and the first node are connected to different leaf switches, and wherein the different leaf switches are connected to a same spine switch.

14. The first node according to claim 9, wherein the processor is configured to invoke the computer program to:
in response to all of the plurality of pods having a same load, select a pod with a smallest weight from the plurality of pods as the target pod; or
in response to the plurality of pods having a different load, select the target pod from the plurality of pods based on the load of each of the plurality of pods and the weight of each pod.

15. The first node according to claim 9, wherein the processor is configured to invoke the computer program to:
after selecting the target pod from the plurality of pods based on the weight of each pod, direct the currently to-be-processed task in the first node to the target pod to indicate the target pod is to process the currently to-be-processed task.

16. A load balancing system, comprising a control node and at least two computing nodes, wherein the at least two computing nodes comprises a first node, and the control node is configured to manage the at least two computing nodes, and wherein a first node of the at least two computing nodes is configured to:
determine topology information of each of a plurality of smallest management units pods in the load balancing system, wherein the plurality of pods are distributed on at least two nodes;
determine a weight of each of the plurality of pods based on the topology information of each pod; and
select a target pod from the plurality of pods based on the weight of each pod, wherein the target pod is configured to process a currently to-be-processed task in the first node.

17. The load balancing system according to claim 16, wherein the plurality of pods are distributed on the at least two computing nodes.

18. The load balancing system according to claim 16, the load balancing system is deployed by using a Kubernetes platform.
